(19) United States
(12) Patent Application Publication
(10) Pub. No.: US 2026/0342169 A1
(43) Pub. Date: Oct. 29, 2026

(54) A HOUSING FOR A LINEAR POWER SYSTEM

(71) Applicant: Libertine FPE Ltd, York (GB)

(72) Inventor: Samuel Edward Cockerill, York (GB)

(73) Assignee: Libertine FPE Ltd, York, OT (GB)

(21) Appl. No.: 19/122,129

(22) PCT Filed: Oct. 13, 2023
(86) PCT No.: PCT/GB2023/052669

§ 371 Date: Apr. 17, 2025

(30) Foreign Application Priority Data
Oct. 17, 2022 (GB) 2215325.8

(51) Int. Cl. H02K 5/20; F28F 9/22; F28F 9/26; H02K 9/193; H02K 41/02

(52) U.S. Cl. CPC H02K 5/203; F28F 9/22; F28F 9/26; H02K 9/193; H02K 41/02

(57) ABSTRACT

A housing segment for a linear power system includes, a linear section having at least two channels for containing and directing a cooling fluid; and an end section configured to provide at least one fluid diversion channel. The end section is connected to one of the at least two channels at one end of the linear section for causing counterflow compared to an adjacent channel of the linear power system.

The present invention relates to housing of a linear power system.

A Linear Power System (LPS) may be formed incorporating at least one Linear Electrical Machine (LEM) and Linear Thermofluidic System (LTFS). A Free Piston Mover (FPM) may generally be a piston of a conventional combustion engine, or may be a Translator of a LEM, or a Piston of a LTFS.

A LPS may further be incorporated within a Free Piston Linear Generator (FPLG), a Linear Motor Reciprocating Compressor (LMRC), a Free Piston Gas Expander (FPGE), a Linear Motor Reciprocating Pump (LMRP) or a Linear Motor Reciprocating Actuator (LMRA) or other type of Linear Power System product.

These various types of Linear Power System (LPS) product, each incorporating one or more FPMs, are well known in themselves. In each case there is a Linear Electro-Mechanical System and a Linear Thermo-Fluidic System which are coupled through the linear motion of the Free Piston Mover.

In addition to the control method employed for control of FPMs within Linear Electrical Mechanical Systems (LEMS) other limitations in the prior art limit the ability to exploit the benefits of LEMs. For example, the ability to operate the LEM to apply a force on the LTFS for extended periods relies on the effective rejection of heat from the LEM to a coolant fluid.

In addition, the ability to adapt a reaction in a working chamber and control the motion of the LEM and the resulting compression ratio, relies on having accurate information about the system within which they are operating. Reducing the variance in as many parameters of the system as possible can reduce the processing required to run the LPS. One example of this is to implement a cooling system to maintain a constant, known, or predictable temperature.

According to one aspect there is provided a housing segment for a linear power system, the segment comprising a linear section comprising at least two channels for containing and directing a cooling fluid; and an end section configured to provide at least one fluid diversion channel connected to one of the at least two channels at one end of the linear section for causing counterflow compared to an adjacent channel of the linear power system.

In a specific optional example of the above housing segment, the end section may be configured to provide at least one fluid diversion channel connected to two or more of the at least two channels at one end of the linear section.

The at least one fluid diversion channel may comprise a shaped cavity within the end section having at least one fluid entry aperture and at least one fluid exit aperture. The shaped cavity may be U shaped or L-shaped. The end section may be a manifold and the at least one fluid diversion channel may be forked.

The end section may be sealed to the linear section by a face seal. The at least one fluid diversion channel of the end section may be connected to any one of the at least two channels at one end of the linear section by a respective plug seal.

The end section may be configured to be connected to more than one linear section. The linear section may be an extruded section, i.e. formed by a process of extrusion. The end section may be a cast section, i.e. formed by a process of casting.

Two or more housing segments may be form the total housing of a linear power system along a longitudinal axis of the system, each segment comprising: at least two linear sections each comprising at least two channels for containing and directing a cooling fluid; and
at least one end section configured to provide at least one fluid diversion channel between at least one of the channels of each of the at least two linear sections for causing counterflow compared to an adjacent channel of the linear power system.

One of the end sections may be a manifold configured to comprise a fluid diversion channel comprising a U shaped cavity which is forked for splitting one inlet channel into two outlet channels. The housing segment may be half of the total housing of a linear power system along a longitudinal axis of the system, and the segment may comprise three linear sections and three end sections arranged to provide an isolated counterflow cooling system.

The isolated counterflow cooling system may be configured to direct cooling fluid through at least one first channel of a linear section, then at least one fluid diversion channel of an end section, then at least one second channel of a linear section, then at least one fluid diversion channel of an end section, then at least one third channel of a linear section, then at least one fluid diversion channel of an end section configured to split the at least one channel into two outlet channels, then at least two fourth channels of a linear section, then at least two fluid diversion channels of an end section, then at least two fifth channels of a linear section, then at least two fluid diversion channels of an end section, and finally at least two sixth channels of a linear section.

The counterflow channels of the linear sections may be configured such that at least one first channel is adjacent to at least one sixth channel, at least one second channel is adjacent to at least one fifth channel, and at least one third channel is adjacent to at least one fourth channel, where the numerical order of the channels follows the order of flow of the cooling fluid through the channels.

In use, the thermal energy of the contents of the channels may increase from the first channel to the sixth channel.

The at least two fourth, fifth, and sixth channels may be positioned one on each side of the at least one third, second, and first channels respectively within a total of three linear sections.

Two or more housing segments may provide a system of counterflow cooling channels. The mean temperature of coolant within each housing segment is preferably approximately equal.

At least one of the linear sections may have a length shorter than half of the total length of the linear power system by at least the width of two end sections. At least one of the linear sections may have a length shorter than the total length of the linear power system by at least the width of two end sections.

Also disclosed is a section of housing of a linear power system, the section being formed by a process of extrusion and comprising at least two channels suitable for implementing a counterflow cooling system and configured to have a cooling fluid therein.

Whilst a housing segment may include two channels described above, an alternative segment is also disclosed. Thus, a housing segment for a linear power system may be provided, the segment having an extruded linear section having a channel therethrough and a flow modifying insert at least partially within the channel, the flow modifying insert being one of a turbulator component, an accelerator component or a plug seal component.

A housing for a linear power system may be formed from multiple housing segments. All of the segments may comprise a single channel or multiple (two or more) channels. The housing may include segments having different numbers of channels, i.e. one or more with a single channel and one or more with multiple channels.

Any discussion herein of features of the turbulator component, the accelerator component or the plug seal component in relation to either a one channel or a multi channel segment apply equally irrespective of the number of channels in a segment.

Also disclosed is a method of manufacturing a housing segment for a linear power system comprising; extruding the segment having at least one channel and inserting a component into at least one channel of the segment, the component being any of a turbulator component, an accelerator component or a plug seal component.

Also disclosed is a cooling system for a linear power system, the cooling system comprising a housing segment a described above and a plug seal component configured to connect at an end of a channel of the housing segment such that a seal is created between the plug and the inner surface of the channel to seal the cooling fluid therein.

The cooling system may comprise a plurality of housing segments joined together by one or more plug seal components. The cooling system may comprise a housing segment as described above and a flow acceleration component configured to be located within a channel of the housing segment and having an internal channel of a reduced cross-sectional area compared to the channel of the housing segment. The internal channel of the flow acceleration component may be coaxially aligned with the channel of the housing segment. The cooling system may comprise a plurality of housing segments, each housing segment containing one or more flow acceleration components.

The cooling system may comprising a housing segment as described above and a turbulator component configured to be located within a channel of the housing segment and shaped such that it disrupts the linear flow of cooling fluid along the channel of the housing segment. The turbulator component may comprise at least one protuberance configured extend from an internal wall of the channel of the housing segment to block the flow of the cooling fluid along at least part of an axial region of the channel. The turbulator component may comprise a plurality of protuberances configured to form at least one baffle structure, the protuberances extending from opposite sides of the internal wall of the channel of the housing segment.

The cooling system may comprise one or more housing segments as described above and any combination of components selected from: an interior plug component as described above, a flow acceleration component as described above, a turbulator component as described above.

The present invention will now be described by way of example with reference to the accompanying drawings. In the drawings:

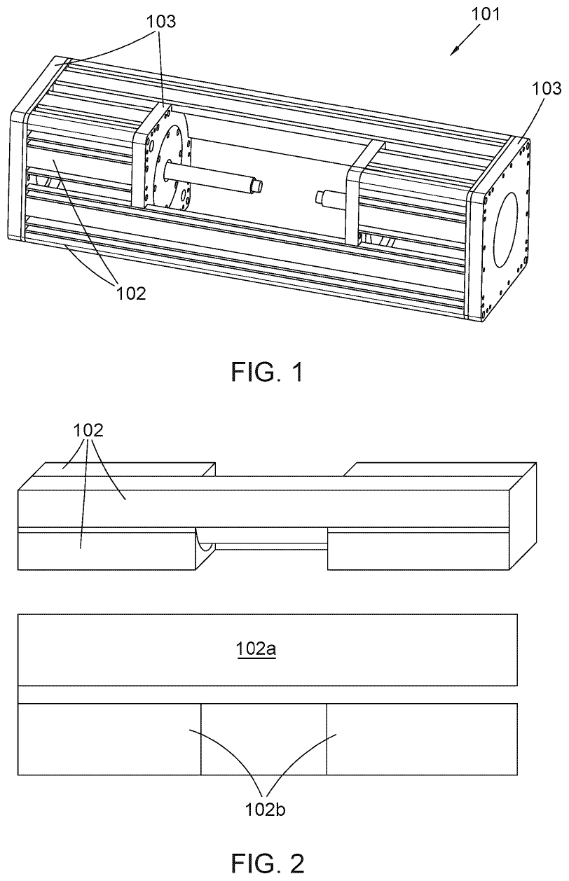

FIG. 1 shows a simplified external view of an example of a Linear Power System.

FIG. 2 shows an example of the linear parts of a housing which may be formed by a process of extrusion.

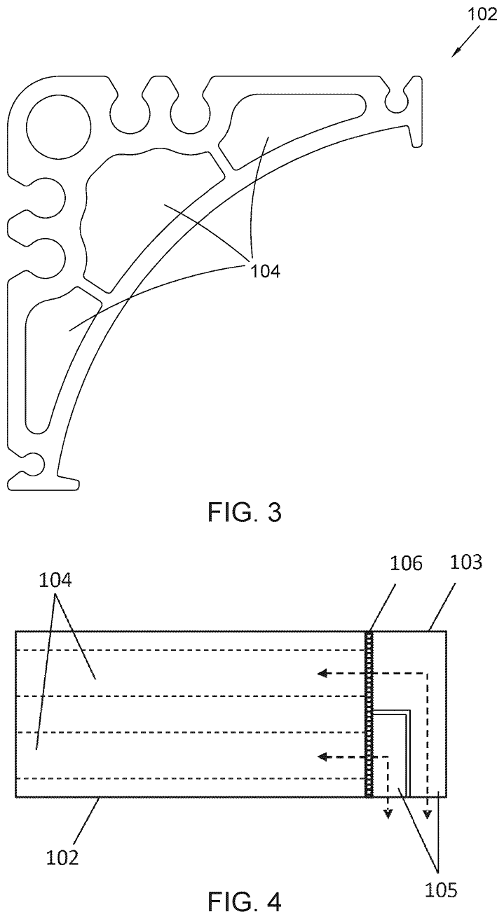

FIG. 3 shows a cross-sectional view of an example linear section of the housing.

FIG. 4 shows an example end section connected to the end of a linear section.

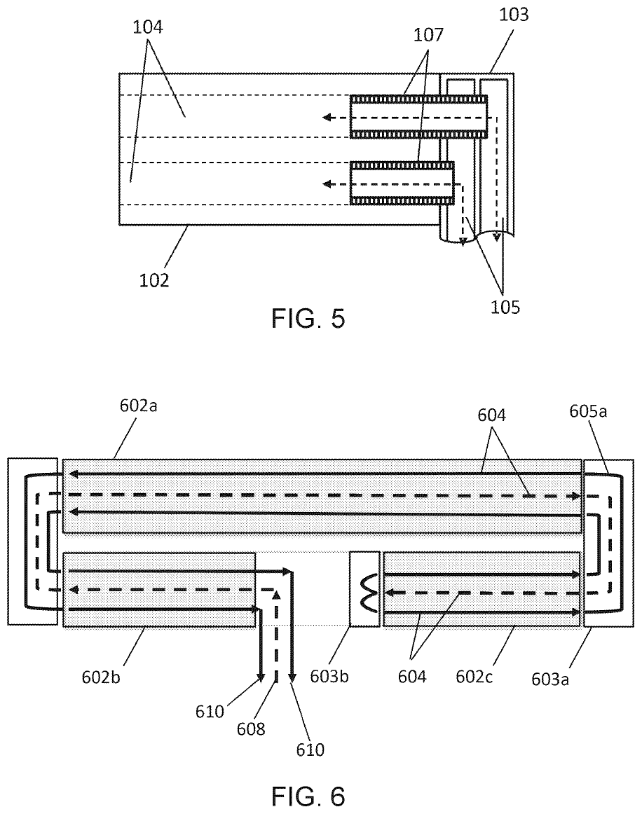

FIG. 5 shows an example end section connected to the end of a linear section.

FIG. 6 shows a schematic drawing of an example housing segment comprising a plurality of extruded linear sections and a plurality of end sections.

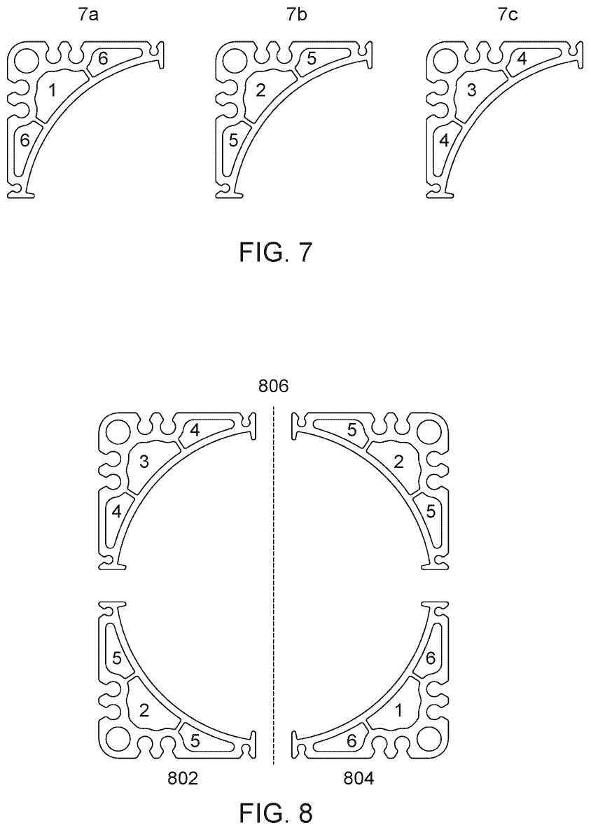

FIG. 7 shows an example flow pattern in each of the linear extruded sections of the example shown in FIG. 6.

FIG. 8 illustrates an example arrangement of two housing segments comprising a plurality of linear housing sections having a flow pattern which results in a substantially balanced thermal energy across the housing of the linear power system.

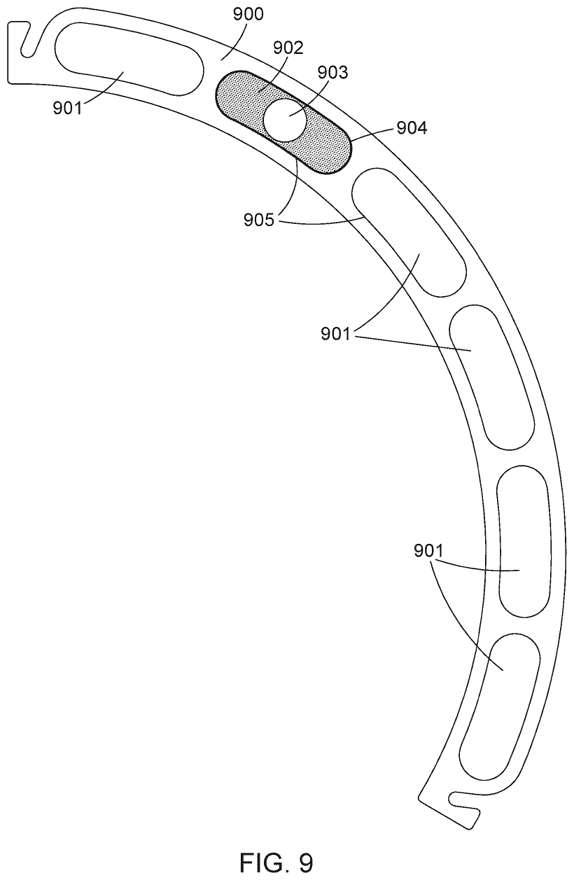

FIG. 9 shows a cross-section of another example of an extruded housing segment in which a section through a plug seal component is shown in one of the channels.

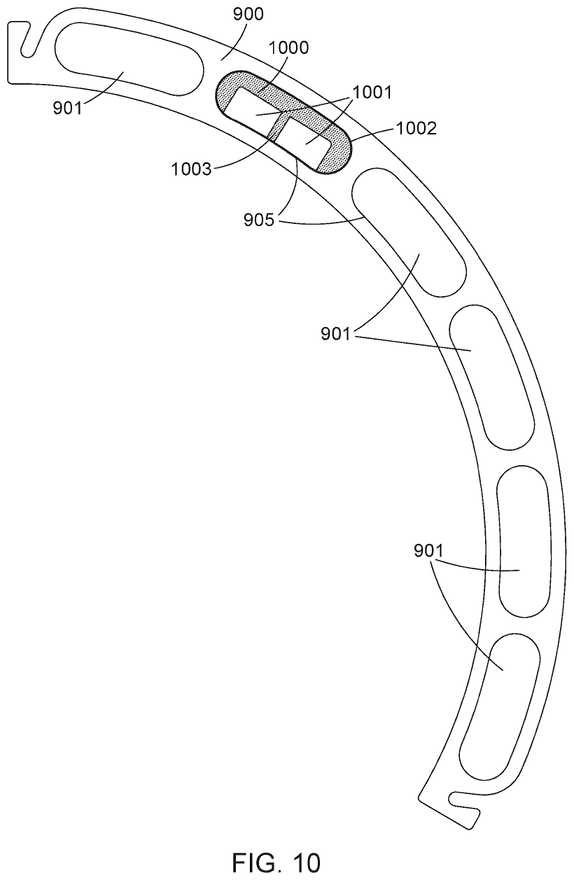

FIG. 10 shows a cross-section of another example of an extruded housing segment in which a section through a flow accelerator component is shown in one of the channels.

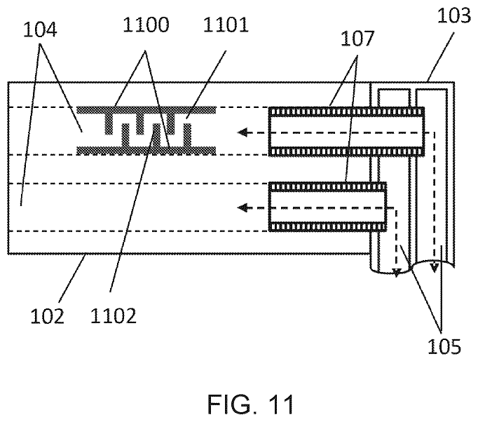

FIG. 11 shows an example section of a of turbulator component within a linear section of a housing.

There is described herein a housing segment for a linear power system. The segment comprises a linear section having at least two channels for containing and directing a cooling fluid. The segment also comprises an end section configured to provide at least one fluid diversion channel. The fluid diversion channel is connected to one of the at least two channels at one end of the linear section for causing counterflow compared to an adjacent channel of the linear power system.

FIG. 1 shows a simplified external view of an example of a Linear Power System (LPS). The Free Piston Mover (FPM) and other key features of the Linear Electrical Mechanical System (LEMS) and Linear Thermofluidic System (LTFS) found within the LPS example depicted in FIG. 1 are not shown for clarity. Many alternative LPS implementations are possible, each comprising at least one LEMS and one LTFS.

The housing 101 is formed from a plurality of parts or sections. The sections may be manufactured by a process of extrusion or casting. Depending on the shape of the part, it can often be more time effective and cost effective to manufacture a part in a specific way. For example, linear sections with continuous cross-section details or features can be easily manufactured to any desired length by the process of extrusion. Whereas other parts with specific shapes, including corners and internal structural details which are not linear, may be more efficiently manufactured by the process of casting.

The housing shown in FIG. 1 comprises liner sections 102. The linear sections 102 are the main structural components of the LPS housing which define the overall size, the width and depth of the sides, and provide the longitudinal edges of the housing 101.

The housing 101 further comprises end sections 103. The end sections are used to hold the linear sections together and/or provide one or more caps at an end of one or more linear sections. As such, the housing 1 may comprise a plurality of linear sections and a plurality of end sections.

FIG. 2 shows an example of the linear parts 102 of a housing 101 which may be formed by a process of extrusion. The linear sections are substantially straight with a structure having a continuous cross-section. It is therefore efficient to produce these linear sections using the method of extrusion. The housing 101 may comprise linear sections of different lengths. FIG. 2 shows six linear sections 102 arranged to form a single LPS housing configuration, where two of the six linear sections 102a have a length substantially the same as the length of the entire LPS housing 101 and four of the six linear sections 102b have a length shorter than half of the length of the entire LPS housing 101. These different length linear sections 102a and 102b are depicted side-by-side at the bottom of FIG. 2.

There is described herein a section of housing of a linear power system. The section formed by a process of extrusion and comprising at least two channels suitable for implementing a counterflow cooling system and configured to have a cooling fluid therein.

FIG. 3 shows a cross-sectional view of an example linear section 102 of the housing 101. From this view it is possible to see the internal structure of the section and illustrate the suitability for production by extrusion. This cross-section is the same at any point along the length of the linear section as well as at any exposed end of a linear section. The cross-section shows a plurality of cavities or channels which run the length of the linear section.

The shape, orientation, and number of channels within the linear section depends on the required strength, stress points, and number of separate channels desired for the purpose of the section. In this example cross-section, it can be seen that this linear section makes up one longitudinal edge of a LPS housing and is shaped to accommodate the cylindrical bore of the FPM and associated components. As such, channels 104 closest to the centre of the LPS may be most suitable for particular functions such as cooling systems.

Thus, there is described herein a linear section of housing for a LPS comprising channels suitable for containing and directing a cooling fluid. The linear section may be an extruded housing section having two or more cavities within it and being suitable for providing a fluid-based cooling system.

FIG. 4 shows an example end section or cap 103 connected to the end of a linear section 102. The end section may be formed by a process of casting. The example end section 103 as shown in FIG. 4 comprises two channels 105. The two channels 105 are suitable for providing a fluid-based cooling system such that the fluid can flow through one or more of the channels 104 of the linear section 102 and on into one or more of the channels 105 in the end section 103. The cooling fluid may flow in the opposite direction to that previously described, that is from the channels 105 of the end section 103 into the channels 104 of the linear section 102. The end section 103 may comprise a single fluid diversion channel which is connected at each of its ends to one of each of the at least two channels of the same linear section. As such, the at least one fluid diversion channel may comprise a U shaped cavity within the end section.

As shown in the example end section of FIG. 4, the end section may comprise one or more than one fluid diversion channel. Each of these fluid diversion channels may be connected to a different respective channel of the linear section of the housing segment and be configured to be connected at the opposite ends of the one or more fluid diversion channels to channels of another different linear section. In such a case, the at least one fluid diversion channel may comprise an L shaped cavity within the end section. Cooling fluid may then be diverted towards another different linear section with respective channels. The end section may therefore be configured to be connected to more than one linear section.

In another example, the end section may comprise a manifold such that the fluid diversion channel is forked. That is, the cavity of the end section which forms the fluid diversion channel may split from one channel into two or more channels or vice versa. In an example embodiment, the manifold may comprise a forked U shaped cavity, such that one channel splits into two channels and all three ends thereof are connected to different respective channels of the same linear section.

In the example of FIG. 4, the end section 103 is sealed to the linear section 102 by a face seal 106. The end surface of the extruded linear section 102 is sealed to another face or part of a surface of the end section 103. The end section 103 is designed such that the openings to the one or more channels of the end section line up with the openings of the respective channels of the linear section. The openings of the channels of the linear section and the end section may not be the same size. The face seal may join the two sections together around the circumference of the end of the linear section. The face seal may join the sections together around the circumference of the end of the linear section and at the ends of all internal walls of the linear section where they meet a surface of the end section.

FIG. 5 shows another example end section or cap 103 for being sealed to the end of an extruded linear housing section 102. In this example the end cap 103 is sealed to the linear housing section 102 using a plurality of plug seals 107. Each of the channels within the linear section 102 and corresponding channel of the end section 103 may be sealed together with a respective plug seal. The plug seal may join the linear housing section and end section together. The plug seal may not only join the linear housing section and the end section together, but also form a bridging channel which seals off and isolates the continuous channel from the linear section to the end section from other channels of the linear section. The continuous channel formed between a channel of the linear section and a fluid diversion channel of the end section by the respective plug seal provides a pathway along which a cooling fluid can flow. Thus, the at least one fluid diversion channel of the end section is connected to any one of the at least two channels at one end of the linear section by a respective plug seal.

FIG. 6 shows a schematic drawing of an example housing segment comprising a plurality of extruded linear sections 602 and a plurality of end sections 603. The flow of cooling fluid is an example of a counterflow cooling system. The counterflow cooling system utilises the channels 604 within the extruded linear sections and the channels 605 within the end sections to contain and direct the cooling fluid. The system is considered to be a counterflow system as the flow doubles back on itself such that input cooling fluid flows adjacent to and in the opposite direction within the system to output cooling fluid which has absorbed thermal energy from the system. Such a counterflow system reduces thermal stresses on the system as a whole and provides a more efficient cooling mechanism. An example of the possible direction of flow, or flow pattern, of the fluid in the cooling system is illustrated by the arrows shown in FIG. 6. Each arrow represents a single channel along which cooling fluid flows in the direction of the arrow.

The illustrated flow pattern may also allow for undesirable lateral exchange of heat from cooling fluid which has already absorbed heat from the surrounding environment, in this case a linear power system, to cooling fluid which has recently entered the channels of the linear power system's cooling system. This undesirable lateral exchange of heat may be reduced or minimised by appropriate design of the plug seal, flow accelerator and/or turbulator components housed within the channels.

The example housing segment is half of the total housing of a linear power system along a longitudinal axis of the system. The segment comprises at least two linear sections 602 each comprising at least two channels 604 for containing and directing a cooling fluid. The segment also comprises at least one end section 603 configured to provide at least one fluid diversion channel 605 between at least one of the channels of each of the at least two linear sections for causing counterflow compared to an adjacent channel of the linear power system.

FIG. 6 shows two different types of end section 603. One type of end section 603a has at least one channel 605a which connects one channel 604 in each of the two linear sections 602a and 602c. thus counterflow is caused in adjacent channels of different linear sections 602a and 602c. End section 603a comprising two channels 605a means that counterflow in adjacent channels 604 of the same linear section 602a or 602b can be achieved. Another type of end section 603b has at least one channel 605 which connects two channels 604 of the same linear section 602c. Such an end section 603b is a manifold configured to comprise a fluid diversion channel comprising a U shaped cavity which is forked for splitting one inlet channel into two outlet channels. Thus counterflow is caused within two channels 604 of the same linear section 602c.

In an example configuration, the housing segment is half of the total housing of a linear power system along a longitudinal axis of the system, and the segment comprises three linear sections and three end sections arranged to provide an isolated counterflow cooling system, such as a cooling loop. The example configuration specifically illustrated in FIG. 6 is an example of such a system. It can be seen from FIG. 6 that some linear section may have different lengths. At least one of the linear sections 602b, 602c, has a length shorter than half of the total length of the linear power system by at least the width of two end sections. At least one of the linear sections 602a has a length shorter than the total length of the linear power system by at least the width of two end sections.

It should be understood that the above description does not limit to three linear sections and three end sections to allow for alternative arrangements which provide the same counterflow cooling system for linear power systems. For example, there may be provided an arrangement where one half of the housing comprises two linear section such as section 602a, joined together by an end section such as section 603a, where the counterflow cooling system is completed by one of the linear sections having an end section such as end section 603b attached thereto. Such an arrangement would also provide an isolated counterflow cooling loop system.

By following the route of the example cooling system from inlet 608 to outlets 610, as presented in FIG. 6, it can be seen that the isolated counterflow cooling loop system is configured to direct cooling fluid through at least one first channel of a linear section, then at least one fluid diversion channel of an end section, then at least one second channel of a linear section, then at least one fluid diversion channel of an end section, then at least one third channel of a linear section, then at least one fluid diversion channel of an end section configured to split the at least one channel into two outlet channels, then at least two fourth channels of a linear section, then at least two fluid diversion channels of an end section, then at least two fifth channels of a linear section, then at least two fluid diversion channels of an end section, and finally at least two sixth channels of a linear section.

In this way a counterflow cooling system is provided in which the system inlet and outlet are located close to one another in the same end section, reducing the cost and complexity of necessary coolant fluid pipework and connections to cooling system components external to the isolated counterflow cooling loop system, and which may include a system radiator, header tank, circulation pump, filter and valves.

FIG. 7 shows the flow pattern in cross-section for each of the linear extruded sections of the example segment shown in FIG. 6. Linear section 602b in FIG. 6 contains cooling fluid entering the system, and therefore the coolest fluid, and fluid leaving the system, therefore the hottest fluid. By representing the relative thermal energy in the cooling fluid with a numerical value between 1 and 6 it can be seen how thermal balance is achieved using the proposed counterflow flow pattern. In the example shown in FIG. 6, the numerical value of the thermal energy therefore also dictates the order in which the cooling fluid flows through the channels and in turn has been used to label the channels.

In FIG. 7a linear section 602b is shown in cross section. The channel marked with ‘1’ contains cooling fluid entering the system, and therefore the coolest fluid in the system. The channel marked with ‘6’ contains cooling fluid about to leave the system and therefore the hottest fluid in the system. A small amount of thermal energy may be lost from the two channels 6 into channel 1.

In FIG. 7b section 602a is shown in cross section. The channel marked with ‘2’ contains cooling fluid having entered the system and travelled through channel 1, and therefore the coolest fluid in section 602a. The channel marked with ‘5’ contains cooling fluid about to travel through channel 6 and therefore the hottest fluid in section 602a.

In FIG. 7c section 602c is shown in cross section. The channel marked with ‘3’ contains cooling fluid having entered the system and travelled through channels 1 and 2, and therefore the coolest fluid in section 602c. The channel marked with ‘4’ contains cooling fluid about to travel through channels 5 and 6 and therefore the hottest fluid in section 602c.

The thermal differential between adjacent channels may be maintained by ensuring the flow rate of the cooling fluid is fast enough such that minimal thermal energy is transferred between adjacent channels. Therefore, the illustrated thermal differential between adjacent channels may be maintained by controlling the rate of flow of the cooling fluid through the counterflow cooling system.

It can be seen that the numerical total of the numerical representation of the thermal energy in each section, having the proposed flow pattern, is roughly the same or similar in each linear section. In section 602b the numerical total of the representation of the thermal energy is 13. In section 602a the numerical total of the representation of the thermal energy is 12. In section 602c the numerical total of the representation of the thermal energy is 11.

In the example housing segment of FIG. 6, the counterflow channels of the linear sections are configured such that at least one first channel is adjacent to at least one sixth channel, at least one second channel is adjacent to at least one fifth channel, and at least one third channel is adjacent to at least one fourth channel, where the numerical order of the channels follows the order of flow of the cooling fluid through the channels. As mentioned above, the thermal energy of the contents of the channels increases from the first channel to the sixth channel. The at least two fourth, fifth, and sixth channels may be positioned either side of the at least one third, second, and first channels respectively within a total of three linear sections.

Other arrangements of channels may be used, for example sections comprising two channels per linear section, or sections comprising four channels per linear section. So long as at least two channels are provided, in which counterflow may be caused, any number of further channels may be added and arranged accordingly. The number of channels in a linear section flowing in one direction compared to the number of channels flowing in the opposite direction may be tailored to physically determine or contribute to the thermal energy distribution in the section. The position of channels within the section may also determine how thermal energy is allowed to escape from the section, and subsequently the segment and housing of the linear power system as a whole.

FIG. 8 shows an example arrangement of two housing segments comprising a plurality of linear housing sections. The housing sections have a flow pattern which results in a substantially balanced thermal energy across the housing of the linear power system. That is, at any point along the longitudinal axis of the housing, a cross section will have a thermal energy in each quadrant which is equal or sufficiently similar to provide a substantially thermally balanced housing. The schematic of the housing segment in FIG. 6 is half of the total housing for one linear power system. Thus, in FIG. 8, two segments of housing 802 and 804, separated by a dashed line 806, are illustrated in cross section. The flow pattern has been arranged such that segment 804 has the same flow pattern as shown in FIG. 6 with a cross section taken towards the left-hand end. The segment 802 has the same flow pattern as shown in FIG. 6 with a cross section taken towards the right-hand end, but orientated upside-down compared to the configuration in FIG. 6. This complimentary orientation can be seen from FIG. 1, where two such housing segments are combined.

The housing segment, when arranged alongside another housing segment configured as a complimentary half, provides a system of counterflow cooling channels of approximately balanced thermal equilibrium across each quadrant of a cross-section taken along the longitudinal axis of the total housing of the linear power system.

FIG. 9 shows a cross-section of another example of an extruded housing segment 900 having a plurality of channels 901 and in which a section through a plug seal component 902 is shown. A plug seal component is an interior plug component at least partially within one of the channels which acts to seal fluid within the channel within the interior surface of the extruded component against which a seal may be formed. In this example, and that of the earlier figures, the internal form of the extrusion is part of a circle, such that the full array of 4 extrusions would form a substantially circular opening, so as to surround an electrical machine of circular cross section. It will be understood that other shaped electrical machines are possible, and therefore the internal form of the extrusions could be a different shape to accommodate the form of the electrical machine.

A plug seal component 902 may be located in one or more of the channels 901 and may contain an interior open section 903 through which coolant fluid may flow. The plug seal interior open section profile may in places be circular in form to facilitate sealing with tubular pipes or pipe fixings external to the extruded housing segment 900. The plug seal interior open section profile area may in places be non-circular to maximise the available coolant flow area and thereby minimise coolant flow restriction and losses. The external shape of the plug seal component 902 may not be uniform—by this we mean that the cross-sectional area of the plug seal component 902 may not be constant across its length. In this way, the plug seal component 902 may have a narrow section and a wide section, and which may have a step change in size/area shape or may have a gradual change between sections of different shapes and/or sizes. The narrow and wide sections may have different shaped cross-sectional areas.

The internal open section profile may not be uniform—by this we mean that the cross-sectional area of the internal open section profile may not be constant across its length. In this way, the internal open section profile may have a narrow section and a wide section, and which may have a step change in size/area shape or may have a gradual change between sections of different shapes and/or sizes. The narrow and wide sections may have different shaped cross-sectional areas.

The plug seal component 902 may be formed to include an exterior profile 904 that is similar in shape to the interior profile 905 of the channel in which the plug seal component is located in order to provide means for a coolant fluid seal against the axial surface of the interior profile 905 of the channel. This seal may for example be achieved by an interference fit between the plug seal component 902 and the extruded housing segment 900. Alternatively, a seal may be formed by an adhesive compound or sealing compound or additional seal component placed between the plug seal component 902 and the extruded housing segment 900.

The plug seal component 902 located in an extruded housing segment 900 can make use of the off-tool surface finish achievable by the extrusion manufacturing process, and thereby reduce or eliminate the need for CNC machining or other expensive machining operations to achieve the surface finish necessary for a seal face on the housing segment.

The plug seal component 902 permits a radial-type seal to be formed over an extended axial region of the channel, which permits the use of a higher coolant fluid entry pressure. A higher coolant fluid entry pressure may be used to increase coolant fluid flow rate which is beneficial for coolant loop performance. In addition, a higher coolant fluid entry pressure may be used to permit higher temperature coolant operation or to make use of low boiling point coolant fluids without resulting in phase changes such as boiling or cavitation that are detrimental to coolant loop performance.

The plug seal component 902 is typically located at one or both ends of the extruded housing segment 900—each plug seal component 902 typically protrudes out of the end of the extruded housing segment 900, so as to seal with another component, but a plug seal component 902 may be wholly contained with the extruded housing segment 900.

FIG. 10 shows a cross-section of an extruded housing segment 900 having a plurality of channels 901 and in which a section through a flow accelerator component 1000 is shown. A flow acceleration component is a component within an axial region of one of the channels which acts to reduce the flow section area of fluid within the channel within that axial region and thereby increase the mean speed of fluid flowing within that section of the channel relative to other axial regions.

A flow accelerator component 1000 may be located in one or more of the channels 901 and may contain one or more open sections 1001 through which coolant fluid may flow. The combined area of the open sections 1001 is smaller than the area of the channel in which the flow accelerator component is located. As a result, coolant flowing within the axial region of channel occupied by a flow accelerator component 1000 will flow at a higher velocity than flow in any axial region of channel unoccupied by a flow accelerator or other component. A higher coolant flow velocity may be expected to result in a reduced coolant fluid flow boundary layer thickness and therefore an improved rate of heat transfer from the extruded housing segment to the coolant, for a given temperature differential between the mean temperature of the housing and that of the coolant fluid.

The flow accelerator component 1000 may be formed from a thermally insulating material, and the exterior profile 1002 of the flow accelerator component 1000 may be formed in certain regions to be similar in shape to the interior profile 905 of the channel in which the flow accelerator component is located. This may have the effect of reducing heat transfer into coolant fluid from fluid in adjacent housing channels or from other heat sources or reservoirs. This effect may desirable in regions of the channel profile 905 where this heat transfer into the coolant fluid is detrimental to coolant loop performance.

Alternatively the flow accelerator component 1000 may be formed from a thermally conducting material, and the exterior profile 1002 of the flow accelerator component 1000 may be formed to create one or more fin support features 1003. This may have the effect of increasing heat transfer from the housing to the coolant fluid. This effect may desirable in regions of the channel profile 905 where this heat transfer into the coolant fluid is beneficial to coolant loop performance.

In addition, fin support features 1003 may have the effect of supporting the channels 901 to prevent local deformation or collapse of the housing channels under the action of pressure external to the channels which may be applied during manufacture or during operation.

FIG. 11 shows an example section of a of turbulator component 1100 within a linear section of a housing 102. A turbulator component is a component within an axial region of one of the channels which acts to create flow turbulence within the fluid contained and flowing within the channel within that axial region and thereby reduce the flow boundary layer thickness within that section of the channel relative to other axial regions.

A turbulator component 1100 may be located in one or more of the channels 104 and may contain an open passage 1101 through which coolant fluid may flow. The shape or form of the open passage 1101 may be convoluted such that there is no straight line path between the axial ends of the turbulator component 1100 in the channel 104. By this, we mean that the fluid must change direction within the component. This can be seen in FIG. 11 by way of the “interlocking” projections 1102. These in effect obstruct the entirety of the cross-sectional area of the open passage 1101. Alternatively the area of the open passage 1101 may be partly open. Such an opening would have the effect of providing only a very small flow area (relative to the overall area of the open passage 1101) providing a straight line path between the axial ends of the turbulator component 1100 in the channel 104, with the remainder of the cross-sectional area, and therefore the flow path, being convoluted.

As a result, a proportion of coolant flowing within the axial region of channel occupied by the turbulator component will undergo one or more flow direction changes within the open passage. These flow direction changes may be expected to result in increased coolant fluid flow turbulence and consequently a reduced coolant fluid flow boundary layer thickness and therefore an improved rate of heat transfer from the extruded housing segment to the coolant, for a given temperature differential between the mean temperature of the housing and that of the coolant fluid.

The flow section area of the open passage 1101 is smaller than the flow section area of the axial region of the channel 104 in which it is located. As a result, coolant flowing within the axial region of channel occupied by the turbulator component will flow at a higher velocity than flow in any axial region of channel unoccupied by a turbulator or other component. A higher coolant flow velocity may be expected to result in a reduced coolant fluid flow boundary layer thickness and therefore an improved rate of heat transfer from the extruded housing segment to the coolant, for a given temperature differential between the mean temperature of the housing and that of the coolant fluid.

Each channel 104 may be unoccupied, or may be occupied by a one or more turbulator components 1100 and one or more plug seal components 107 as illustrated in FIG. 11. In addition, each channel may include any combination of one or more plug seal, flow accelerator, and turbulator components.

A turbulator component 1100 may occupy the same axial region of a channel 104 as a flow accelerator component 1000 provided that the turbulator is no larger in profile than the open section 1001 of the flow accelerator component in which it is located. By this, a turbulator might reside within a channel in the flow accelerator component.

A turbulator and/or accelerator component will preferentially be located in an axial region of the extrusion in which the highest temperatures exists, so that the improved heat exchange affect achieved by then sue of those components has the maximum effect on the system.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A housing segment for a linear power system, the segment comprising:
a linear section comprising at least two channels for containing and directing a cooling fluid; and
an end section configured to provide at least one fluid diversion channel connected to one of the at least two channels at one end of the linear section for causing counterflow compared to an adjacent channel of the linear power system.

2. The housing segment according to claim 1, wherein the at least one fluid diversion channel comprises a shaped cavity within the end section having at least one fluid entry aperture and at least one fluid exit aperture.

3. The housing segment according to claim 1, or wherein the at least one fluid diversion channel comprises a U shaped cavity within the end section or an L shaped cavity within the end section.

4. The housing segment according to claim 1, or wherein the end section is a manifold and the at least one fluid diversion channel is forked.

5. (canceled)

6. The housing segment according to claim 1, wherein the end section is sealed to the linear section by a face seal.

7. The housing segment according to claim 1, wherein the at least one fluid diversion channel of the end section is connected to any one of the at least two channels at one end of the linear section by a respective plug seal.

8. The housing segment according to claim 1, wherein the end section is configured to be connected to more than one linear section.

9. The housing segment according to claim 1, wherein the linear section is formed by a process of extrusion.

10. (canceled)

11. The housing segment according to claim 1, the segment comprising:
at least two linear sections each comprising at least two channels for containing and directing a cooling fluid; and
at least one end section configured to provide at least one fluid diversion channel between at least one of the channels of each of the at least two linear sections for causing counterflow compared to an adjacent channel of the linear power system.

12. The housing segment according to claim 1, wherein one of the end sections is a manifold configured to comprise a fluid diversion channel comprising a U shaped cavity which is forked for splitting one inlet channel into two outlet channels.

13. The housing segment according to claim 1, wherein the housing segment is half of the total housing of a linear power system along a longitudinal axis of the system, and the segment comprises three linear sections and three end sections arranged to provide an isolated counterflow cooling system.

14. The housing segment according to claim 13, wherein the isolated counterflow cooling system is configured to direct cooling fluid through at least one first channel of a linear section, then at least one fluid diversion channel of an end section, then at least one second channel of a linear section, then at least one fluid diversion channel of an end section, then at least one third channel of a linear section, then at least one fluid diversion channel of an end section configured to split the at least one channel into two outlet channels, then at least two fourth channels of a linear section, then at least two fluid diversion channels of an end section, then at least two fifth channels of a linear section, then at least two fluid diversion channels of an end section, and finally at least two sixth channels of a linear section.

15. The housing segment according to claim 14, wherein the counterflow channels of the linear sections are configured such that at least one first channel is adjacent to at least one sixth channel, at least one second channel is adjacent to at least one fifth channel, and at least one third channel is adjacent to at least one fourth channel, where the numerical order of the channels follows the order of flow of the cooling fluid through the channels.

16. (canceled)

17. The housing segment according to claim, wherein the at least two fourth, fifth, and sixth channels are positioned one on each side of the at least one third, second, and first channels respectively within a total of three linear sections.

18. The housing segment according to claim, wherein the housing segment, when arranged alongside another housing segment, provides a system of counterflow cooling channels in which the mean temperature of coolant within each housing segment is approximately equal.

19-20. (canceled)

21. A cooling system for a linear power system, the cooling system comprising:
a housing segment formed by a process of extrusion and comprising at least two channels suitable for implementing a counterflow cooling system and configured to have a cooling fluid therein; and one or more of:
a plug seal component configured to connect at an end of a channel of the housing segment such that a seal is created between the plug and the inner surface of the channel to seal the cooling fluid therein;
a flow acceleration component configured to be located within a channel of the housing segment and having an internal channel of a reduced cross-sectional area compared to the channel of the housing segment; and
a turbulator component configured to be located within a channel of the housing segment and shaped such that it disrupts the linear flow of cooling fluid along the channel of the housing segment.

22-25. (canceled)

26. The cooling system according to claim 21, wherein the cooling system comprises a plurality of housing segments joined together by one or more plug seal components.

27. The cooling system according to claim 21, wherein the internal channel of the flow acceleration component is coaxially aligned with the channel of the housing segment.

28. The cooling system according to claim 21, wherein the turbulator component comprises at least one protuberance configured extend from an internal wall of the channel of the housing segment to block the flow of the cooling fluid along at least an axial region of the channel.

29. The cooling system according to claim 21, wherein the turbulator component comprises a plurality of protuberances configured to form at least one baffle structure, the protuberances extending from opposite sides of the internal wall of the channel of the housing segment.

30. (canceled)
